(19) United States
(12) Patent Application Publication
(10) Pub. No.: US 2007/0209059 A1
(43) Pub. Date: Sep. 6, 2007

(54) Communication system employing a control layer architecture

(76) Inventors: John A. Moore, Carrollton, TX (US); Matthew N. Bowers, Dallas, TX (US); Arvind Gurudas Betrabet, Murphy, TX (US)

Correspondence Address: SLATER & MATSIL, L.L.P., 17950 PRESTON RD, SUITE 1000, DALLAS, TX, 75252-5793, US

(21) Appl. No.: 11/713,279

(22) Filed: Mar. 2, 2007

Related U.S. Application Data
(60) Provisional application No. 60/779,049, filed on Mar. 3, 2006.

(51) Int. Cl. H04L 9/32

(52) U.S. Cl. 726/2

(57) ABSTRACT

A communication system employable with an enterprise that provides applications for a user through a communication device, and method of operating the same. In one embodiment, the communication system includes a policy/user database that stores policies across an enterprise related to the user and the communication device for access to the applications within the enterprise. The communication system also includes a security server that authenticates access of the communication device to the applications based on the policies. The communication system also includes a control server that approves and controls access of the communication device to the applications based on authentication from the security server. The communication system still further includes an audit/traceability server that provides a record of transactions for the access by the communication device to the applications and provides an alert in real time when approval is denied.

This application claims the benefit of U.S. Provisional Application No. 60/779,049 entitled “Enterprise Communications Control Layer Architecture,” filed Mar. 3, 2006, which application is incorporated herein by reference.

### TECHNICAL FIELD

The present invention is directed, in general, to communication systems and, more specifically, to a communication system employing a control layer architecture.

### BACKGROUND

A control layer architecture for enterprise applications and services is beneficial to business structures and processes that have shifted dramatically with the introduction of both computers to support back office functions and advanced communications technologies, which allow extended reach and instantaneous reaction to business needs. This evolution has been continuous and created challenges as businesses modify their operations processes and introduce new technologies. There is also an expectation from the general public for security of individual information and corporate records.

In response to the growing business needs, specific applications have been developed based on the current state of the software and technology art. The applications have been predominantly stand-alone in nature and inter-working with a myriad of other applications has been difficult at best. This isolation or silo nature of applications in an enterprise is widely recognized as an issue that should be resolved if an enterprise is going to be competitive in the twenty-first century.

The need to address the aforementioned issue quickly is being aggravated by governmental actions. Regulatory mandates are expanding as the awareness of how sensitive data is being compromised creates negative social impacts, and the public is demanding action. Only the enterprises that effectively respond to the regulations in a cost-effective manner will remain competitive. The need for automatic creation of a comprehensive audit trail for many aspects of every business is a logical solution to this current trend.

While a reliance of enterprises on computer systems and processes is to be expected, the enterprise becomes extremely vulnerable to a wide range of security threats as a dependence on the systems grows. In addition to the physical threats, there is a long list of potential electronic-based threats ranging from misrepresentation of authority or identity, theft of services, eavesdropping, interception and modification, and intentional interruption of service.

The threats become increasingly difficult to defend against with the globalization of the business environment. Electronic attacks could originate from anywhere on the globe and the attacks may often come from sources that are expected to be friendly, such as customers or partners. Consistent approaches that can be implemented and controlled on a global basis should also cross boundaries between these groups. Isolating an enterprise communication network, while assuring security, is unworkable, as it negates the ability of the enterprise to conduct business. Inter-network control is not possible with current enterprise approaches. Any enterprise can only achieve border control of its communication networks, and additional security measures are applied on a service-by-service basis, leading to increased exposure to risk.

Additionally, enterprise information technology networks are based on packet switched networks with application silos. Initially, each business application is developed independently and operated as a separate process or silo. Despite the best efforts of software developers to unify access to information using a single application program and database-like enterprise resource planning (“ERP”), there remains a daunting task of extending the complex concepts as enterprises merge and divide without losing the overall control of the business.

Accordingly, what is needed in the art is a system and method that provides a control layer architecture for a communication system employable in an enterprise communication network that overcomes the deficiencies in the prior art.

### SUMMARY OF THE INVENTION

To address the aforementioned limitations, the present invention provides a communication system employable with an enterprise that provides applications for a user through a communication device, and method of operating the same. In one embodiment, the communication system includes a policy/user database that stores policies across an enterprise related to the user and the communication device for access to the applications within the enterprise. The communication system also includes a security server that authenticates access of the communication device to the applications based on the policies. The communication system also includes a control server that approves and controls access of the communication device to the applications based on authentication from the security server. The communication system still further includes an audit/traceability server that provides a record of transactions for the access by the communication device to the applications and provides an alert in real time when approval is denied.

The foregoing has outlined rather broadly the features and technical advantages of the present invention in order that the detailed description of the invention that follows may be better understood. Additional features and advantages of the invention will be described hereinafter, which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a diagram of an enterprise communication network that provides an environment for a communication system constructed according to the principles of the present invention;

FIG. 2 illustrates a diagram of an embodiment of a communication system employable in a communication network constructed according to the principles of the present invention; and

FIGS. 3 and 4 illustrate diagrams of a carrier communication network employable with a communication system constructed according to the principles of the present invention; and

FIG. 5 illustrates a call flow diagram of an embodiment of a method of operating a communication system according to the principles of the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The communication system (also referred to as “system”) of the present invention provides an architecture and system that is capable of providing a control layer for a communication network such as an enterprise communication network. The system is compatible with a plurality of wireless and wired networks for carrying multimedia content to a variety of communication devices such as remote access terminals and devices. The system is employable with a multitude of networks including, without limitation, global system for mobile communication (“GSM”), general packet radio services (“GPRS”), enhanced data GSM environment (“EDGE”), universal mobile telecommunications service (“UMTS”), code-division multiple access (“CDMA”), evolution data only (“EVDO”), evolution data voice (“EVDV”), integrated digital enhanced network (“iDEN”), wireless fidelity (“Wi-Fi”), WiMAX, satellite communications (“SATCOM”), public switched telephone network (“PSTN”) and the internet. Of course, any combination of mobile wireless, fixed wireless or wired networks may be employed in conjunction with the systems of the present invention.

The system and method of the present invention will hereinafter be described with respect to preferred embodiments in a specific context, namely, in the environment of a communication network and related methods of delivering applications and services. The principles of the present invention, however, may also be applied to other types of access points and controllers employable with network architectures. The advantages associated with the system further exploit the benefits associated with a control layer for a communication system employable with an enterprise communication network that extends the boundaries thereof, while, at the same time, enhancing a security of information associated therewith.

Convergence is driving circuit switched voice networks and packet switched networks together, but does not address the application silos or the almost constant change in the enterprise environment. Business applications in an internet protocol (“IP”)-based network such as the worldwide web lack cohesive control and security. Policies are applied over a silo, or possibly a few silos that have been merged, and not an entire enterprise. Service oriented architecture (“SOA”) is a methodology that addresses how software can be written to join services together across silos, but it does not address the overriding security issues facing business today. Federated identity is one approach to solve the issue, but it applies to a subset of potential participants and does not offer a homogeneous approach that will work between enterprises or between an enterprise and multiple communications networks.

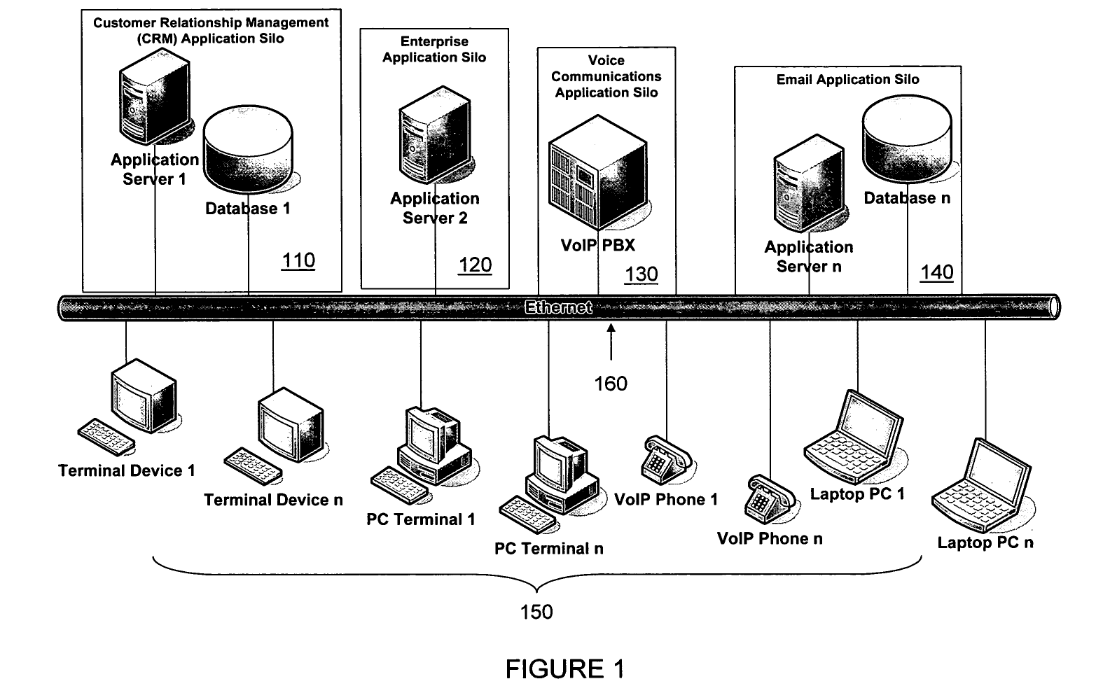

Turning now to FIG. 1, illustrated is a diagram of an enterprise communication network that provides an environment for a communication system constructed according to the principles of the present invention. In the illustrated embodiment, control of the data is based on a transmission control protocol (“TCP”) and control for the voice [e.g., voice of internet protocol (“VoIP”)] is based on session initiation protocol (“SIP”). The enterprise communication network includes a plurality of application silos including a customer relations management (“CRM”) silo 110, an enterprise application silo 120, a voice communications silo 130 and an e-mail application silo 140. The application silos are coupled to a plurality of communication devices (generally designated 150) via a communication bus (e.g., an ethernet bus 160).

As mentioned above, the enterprise faces several issues in accordance with a communication infrastructure associated therewith. For instance, the enterprise faces security issues including intrusion, identity protection, misrepresentation of identity, authority, rights, or content, theft of services, unwanted contact such as harassment and extortion, eavesdropping, interception and modification, and intentional interruption of service like denial of service (“DoS”). The enterprise also faces regulatory mandates such as Sarbanes-Oxley, the health insurance portability and accountability act (“HIPPA”), and the Gramm-Leach Bliley act (“GLB”). The enterprise should also be prepared to provide inter-networking control with remote users or employees, and access to supplier extranets and customer access. The enterprise also controls a multitude of services/applications and should provide data consistency and transparency across the services and applications. Additionally, the enterprise should be capable of dealing with the convergence of voice and data terminals, networks, and applications and provide the ability to audit aspects of the enterprise.

A communication system including a control layer architecture as described herein takes an approach of how to apply a communications architecture approach to an enterprise environment and, by using similar architecture concepts, to create a secure converged environment for applications, services, and communication devices. The communication system includes an architectural design, the devices that enable the architecture, and the methods of using the architecture for specific applications.

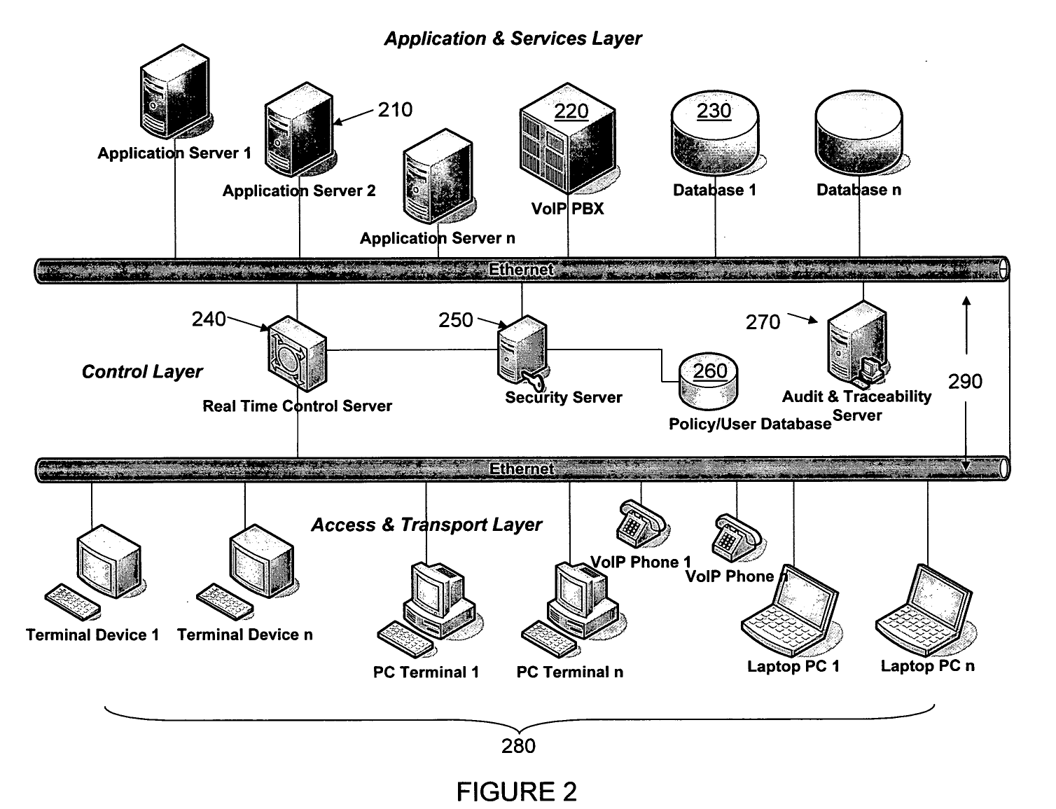

Turning now to FIG. 2, illustrated is a diagram of an embodiment of a communication system employable in a communication network (e.g., an enterprise communication network) constructed according to the principles of the present invention. The enterprise communication network includes an application and services layer with application servers (one of which is designated 210 and a voice server designated 220), and databases (one of which is designated 230). The enterprise communication network also includes a control layer with a control server 240, a security server 250 coupled to a policy/user database 260, and an audit/traceability server 270. The enterprise communication network also includes an access and transport layer with a plurality of communication devices (generally designated 280). The layers of the enterprise communication network are coupled via communication buses (e.g., an ethernet bus, generally designated 290).

Thus, the communication system is employable with an enterprise that provides applications for a user through the communication devices 280. The policy/user database 260 stores policies across an enterprise related to users and the communication devices 280 for access to the applications and services (e.g., via the application servers 210) within the enterprise. The security server 250 authenticates access of the users and the communication devices 280 to the applications and the services based on the policies and in accordance with security measures such as digital rights management and biometric information about a user. The control server 240 approves and controls access of the users and the communication devices 280 to the applications and the services based on authentication from the security server 250. The audit/traceability server 270 provides a record of transactions for the access by the communication devices 280 to the applications and the services, and provides an alert in real time when approval is denied. In accordance therewith, the control server 240 can disable the communication devices 280 when approval is denied.

The communication system including the control layer allows for an application of internet protocol multimedia subsystem (“IMS”) framework architecture to the enterprise communication network. The control layer provides controlled access to and from the sources (intra and extra enterprise) to enterprise applications [e.g., ERP, customer relationship management (“CRM”), supply chain management (“SCM”)] with security and audit capability including access security, network security, application security, and audit record creation. The control layer may access standard radius or diameter servers to assure security compliance. Radius and diameter refers to standards that provide authentication, authorization, and accounting functions and describe a framework for intelligently controlling access to network resources, enforcing policies, and providing information to create certifiable audit services. The control layer provides management of digital rights management (“DRM”) for users such as customers, employees, and partners, and further provides access to or blocks access to applications and data based on the DRM and policy, thereby generating an audit trail of transactions.

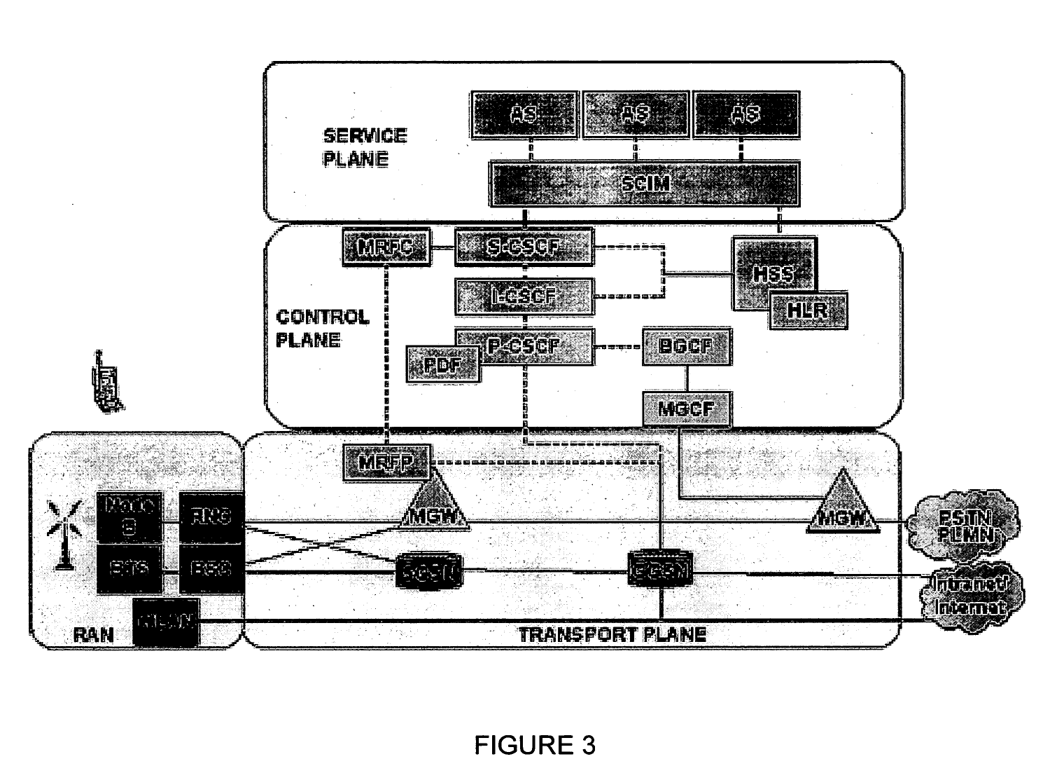

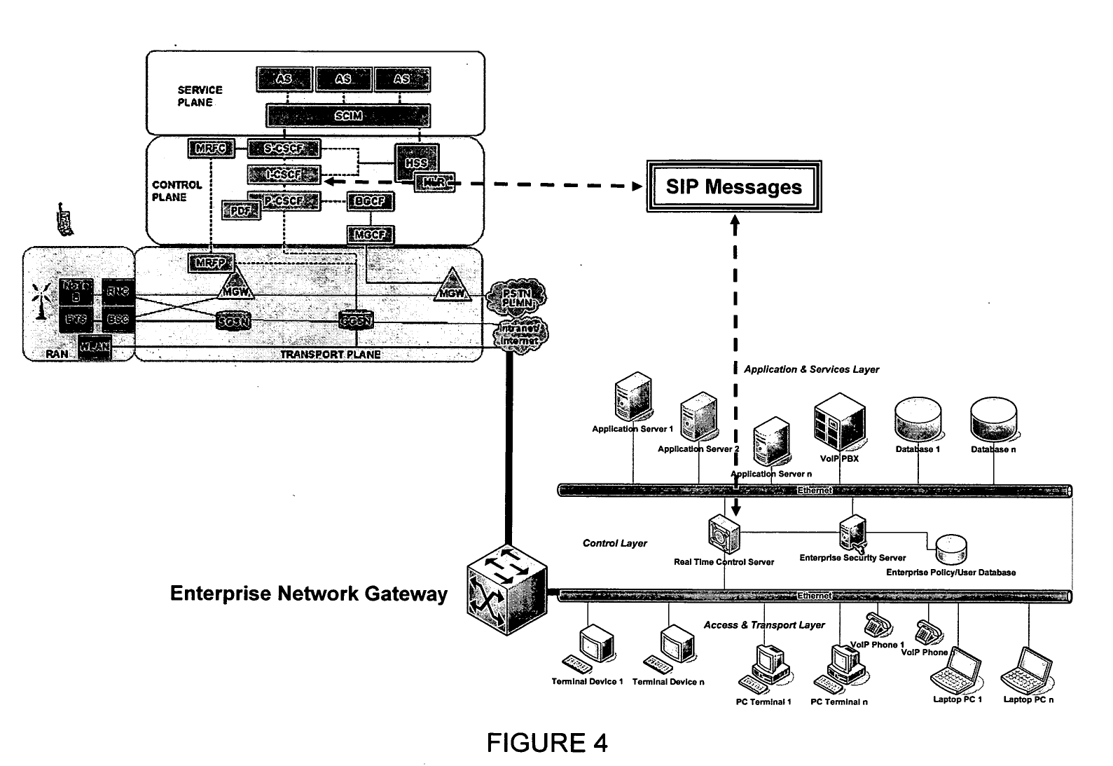

The control layer provides uniform interfaces between the enterprise communication network employing, for instance, an IMS architecture and a carrier's communication network employing an IMS infrastructure (see, e.g., FIG. 3) or circuit switched architecture either directly or through intermediaries, third parties and/or aggregators for extensible communications. Additionally, FIG. 4 illustrates internetworking interfaces for an enterprise communications network and a carrier communication network employing an IMS infrastructure. Also, internetwork control messages pass through an enterprise network gateway, transport channel and carrier gateway router (“GGSN”) to an interrogating call state control function (“I-CSCF”) module as defined below.

The control layer also provides uniform interfaces between the enterprise communication network employing, for instance, an IMS infrastructure and applications (e.g., applications and products in data processing). Use of the control layer to invoke an application or service enables the creation of an audit trail to help fulfill the requirements of present and future regulatory mandates. The control layer also includes subsystems and modules that support home location register/home subscriber server (“HLR/HSS”), a visitor location register (“VLR”), a call state control function (“CSCF”) of all flavors of proxy, interrogating, and serving, a service delivery platform (“SDP”), and a unified management interface, to name a few. For example, the HSS may include the policies and permissions for access devices such as the communication devices 280 to applications and services [such as ERP, SCM, CRM, communications and messaging or external services such as wide area network (“WAN”) communication] at every level for an enterprise.

The control layer enables attributes and capabilities such as an enterprise CSCF to communicate with enterprise applications (e.g., ERP, CRM, SCM) and for integrating IMS, SOA and federated identity for the enterprise. Also, the control layer may use a session initiation protocol in an IMS like enterprise infrastructure for establishing controlled communication with enterprise applications. The control layer can also enable multiple unique identities to be controlled by each group or user and for these identities to be communicated in a secure way with other networks through uniform interfaces. The control layer may also be employed for transmitting and delivering supervisory control and data acquisition (“SCADA”), radio frequency identification (“RFID”) information or other machine to machine protocols or languages in an IMS enabled network with generation of appropriate audit records. The control layer may utilize an IMS compliant SIP protocol and a cohesive DRM approach to the converged enterprise communication network and the communications and information technology infrastructure to enable security and control many aspects of the enterprise. The control layer can also enable “edge” aggregation devices, whether in an enterprise or operator network, to actively inspect, assess, and act upon malicious or potentially malicious data/information using deep packet inspection coupled with the capability of evaluating and acting upon identified information.

The control layer also enables end users from the communication devices 280, whether that be a laptop computer, desktop computer, cell phone, personal digital assistant (“PDA”), smart phone, voice over internet protocol phone, instant messaging client residing on a communication device, or other device, to access information by utilizing a small footprint semantic search capability that either resides on the communication device 280 itself, at the enterprise, at a third party, or within an operators network. This search applies to internal enterprise information as well as entertainment (e.g., music and film) and any other information a user seeks. For an example of a semantic search in view a communication device, see U.S. patent application Ser. No. 11/640,039 entitled “Communication System Employing a Context Engine,” filed Dec. 15, 2006, which is incorporated herein by reference.

In general, there exists an information technology centralization paradigm within the enterprise. This centralization was designed to cost-effectively deploy and manage applications and support information security. However, this paradigm becomes impractical as applications, services and networks become more decentralized. The application of a control layer within the enterprise will serve as a mechanism to allow centralization of elements such as identity, control and access while enabling the decentralization of other applications, thereby facilitating the rapid delivery of more applications to end users.

A proliferation of data will result from the decentralization of information technology and communications within the enterprise (and carriers) and the advent of platforms that make applications and services deployable. To manage and monitor the data may require greater capability at the “edge” of the network. Routers, switches, gateways or other elements deployed at the network edge may need to have greater capability. One example of this capability will be to monitor traffic for malicious information/data and execute specific actions based on whether the information/data is deemed to be malicious or not. This could be done using packet inspection coupled with an application designed to semantically evaluate content and act upon the content. In addition to assessing information at the edge, the data proliferation phenomena will also cause end users to be able to access large quantities of information from communication devices and systems that provide physical challenges to do so. To address this challenge, a small footprint semantic search and retrieval engine could be deployed to clearly identify and access information on behalf of the user. The semantic search engine could be utilized with text, voice or other inputs and deliver to the user information based on a search or direct the user to the closest destination possible given the information given.

Session initiation protocol is a text-based, open signaling, data-centric protocol for establishing any kind of real-time communication, that is designed for flexibility in the enablement of unified communication solutions including those that can be tied to specific business processes. The communication session can involve multimedia including voice, video, images, data or instant messaging, and can take place on one of many devices that users employ for communicating such as laptop computer, PDA, cell phone, instant messaging client, internet protocol (“IP”) phone, and so on. SIP has been developed in the internet engineering task force (“IETF”) by common participation from a large open international community of network designers, operators, vendors, and researchers concerned with the evolution of the internet architecture and its operation. SIP builds on a number of existing communications protocols and may be customized, as necessary. It is rapidly becoming a standard for service integration (how new services and applications are created and combined) within a variety of wireless and carrier networks, and is gaining momentum within enterprises. A SIP system is built completely open to other standards-based architectures and applications such as those built on extensible markup language (“XML”) and simple object access protocol (“SOAP”). For a better understanding of SIP, see “A SIP of SIP,” by Avshalom Houri, Lotus Software—IBM SWG, November 2003, which is incorporated herein by reference.

The basic idea is that the IMS carries signaling and bearer traffic over the IP layer and operates as a routing engine or session control application that matches user profiles with appropriate call/session-handling servers, and then routes the call or session to the appropriate destination. The architecture includes the capability to add, modify, or delete sessions during an existing multimedia communication session or circuit-switched call. This opens possibilities of “blended” services that involve simultaneous voice, data, and multimedia communication sessions.

The most recent technical specification for the third generation partnership project (“3GPP”) network architecture defines IMS as including the core-network elements providing IP multimedia services (such as audio, video, text, chat, and combinations thereof) over the packet-switched domain of the core communication network. The overall network architecture behind this definition has two parts, namely, an access network and a core network. In mobile terms, the access network provides the wireless access points and links to the user and the core network provides service control and the fixed connectivity to other access points, to other fixed networks, and to service resources such as databases, interactive announcements, and content delivery. For a better understanding of IMS, see 3GPP TS 23.228 entitled “Technical Specification Group Services and System Aspects; IP Multimedia Subsystem (IMS); Stage 2 (Release 7),” v7.6.0 (December 2006), which is incorporated herein by reference.

An IP multimedia core network (“IM CN”) includes core network systems for provisioning multimedia services. The core network includes a collection of signaling and bearer related network systems, IP multimedia services are based on an IETF defined session control capability that, along with multimedia bearers, uses the IP-connectivity access network (including an equivalent set of services to a relevant subset of circuit switched services). To achieve access independence and to maintain a smooth interoperation with wireline terminals across the internet, the IP multimedia subsystem attempts to be conformant to IETF internet standards. Therefore, the interfaces specified conform to the IETF internet standards for the cases where an IETF protocol has been selected (e.g., SIP). For a better understanding of the IETF standards, see IETF RFC 3261, entitled “SIP: Session Initiation Protocol,” by the Internet Engineering Task Force (June 2002), which is incorporated herein by reference.

The IP multimedia core network enables public land mobile network (“PLMN”) operators to offer their subscribers multimedia services based on and built upon internet applications, services and protocols. There is no intention here to standardize such services within the IP multimedia core network. The intention is that such services will be developed by PLMN operators and other third party suppliers including those in the internet space using the mechanisms provided by the internet and the IP multimedia core network. The IP multimedia core network should enable the convergence of, and access to, voice, video, messaging, data and web-based technologies for a wireless communication device, and combine the growth of the internet with the growth in mobile communications.

The complete solution for the support of IP multimedia applications includes communication devices, IP-connectivity access networks (“IP-CAN”), and the specific functional elements of the IP multimedia core network described in the 3GPP specification mentioned above. An example of an IP-connectivity access network is the GPRS core network with GSM EDGE radio access network (“GERAN”) and/or UMTS terrestrial radio access network (“UTRAN”). The IP multimedia subsystem utilizes the IP-CAN to transport multimedia signaling and bearer traffic. The IP-CAN maintains the service while the communication device moves and hides the moves from the IP multimedia subsystem. The IP multimedia subsystem is independent of the circuit switched domain although some network elements may be common with the circuit switched domain. Thus, it is not necessary to deploy a circuit switched domain to support an IP multimedia subsystem based network.

The core network is assumed also to have two parts (known as domains), namely, a circuit-switched domain and a packet-switched domain. Circuit-switched connections employ dedicated network resources to be allocated during a connection. The public switched telephone network (“PSTN”) is a classic example of a circuit-switched network. Packet-switched connections do not employ such dedicated resources, as information is broken down into separate short messages (packets), which are routed independently through the network to the destinations and reassembled into the original information streams at the destination. The internet is the classic example of a packet-switched network.

Referring again to FIGS. 3 and 4, illustrated are diagrams of a carrier communication network employable with a communication system constructed according to the principles of the present invention. The carrier communication network includes a service plane, a control plane and a transport plane. The service plane includes a smart common method input (“SCIM”) platform that supports application servers (“AS”). The control plane includes a multimedia resource function controller (“MRFC”) coupled to call session call function (“CSCF”) modules, which are coupled to a home location register/home subscriber server (“HLR/HSS”) and a breakout gateway control function (“BGCF”) module. The breakout gateway control function module is coupled to a media gateway control function (“MGCF”) module. The multimedia resource function controller is coupled to a multimedia resource function processor (“MRFP”) of the transport plane. The media gateway control function module is coupled to a media gateway (“MGW”) of the transport plane.

In addition to the media gateways, the transport plane includes a radio access network (“RAN”) including a base station (“BTS”), base station controller (“BSC”), radio network controller (“RNC”) and wireless local area network (“WLAN”). In addition to the PSTN, a public land mobile network (“PLMN”) is also illustrated herein. The transport plane also includes a gateway GPRS support node (“GGSN”) and a serving GPRS support node (“SGNS”), wherein GPRS refers to general packet radio service.

An IMS architecture as defined with respect to the carrier communication network includes eight basic elements in a packet switched domain as illustrated with respect to FIGS. 3 and 4. The call session control function (“CSCF”) modules act as a proxy CSCF (“P-CSCF”) module, serving CSCF (“S-CSCF”) module, or interrogating CSCF (“I-CSCF”) module. The CSCF modules serve as a centralized routing engine, policy manager, and policy enforcement point to facilitate the delivery of multiple real-time applications using IP transport. The CSCF modules are application-aware and use dynamic session information to manage network resources (e.g., feature servers, media gateways, and edge devices) and to provide advance allocation of these resources depending on the application and user context. The P-CSCF module is the first contact point within the carrier communication network that accepts, serves and forwards requests for a subscriber. The I-CSCF module is the contact point within the carrier communication network for connections destined for a communication device thereof, or for a roaming communication device currently located within that carrier communication network's service area. There may be multiple I-CSCF modules within the carrier communication network. The S-CSCF module is responsible for identifying the device's service privileges, selecting access to an enterprise communication network application server, and providing access to that server.

The MGCF module communicates with CSCF modules and controls the connections for media channels in an IP multimedia subsystem-media gateway (“IMS MGW”). The MGCF module performs protocol conversion between integrated services digital network with user part (“ISUP”) and the IMS call-control protocols. The IMS-MGW may terminate bearer channels from a switched-circuit network and media streams from a packet-switched network. The IMS-MGW may support media conversion, bearer control, and payload processing (for example, codec, echo canceller, or conference bridge).

The MRFC controls the media stream resources in the MRFP. The MRFC interprets information coming from an application server and S-CSCF module and controls the MRFP accordingly. The MRFC also generates call detail records. The MRFP provides a wide range of functions for multimedia resources including provision of resources to be controlled by the MRFC, mixing of incoming media streams, sourcing media streams (for multimedia announcements), and processing of media streams. A subscription locator function (“SLF”) module locates a database containing subscriber data in response to queries from the I-CSCF module or application server. The BGCF module controls the transfer of calls to and from the PSTN. Additionally, the application servers provide value-added IP multimedia services and reside in the enterprise communication network or in a third-party location. The application servers can provide service capability interaction manager (“SCIM”) functions to manage interactions.

There are other elements of the carrier communication network that either span the circuit-switched and packet-switched domains, or provide mobility functionality as set forth below. The home subscriber server (“HSS”) includes the home location register (“HLR”) and the authentication center (“AuC”). A signaling gateway function (“SGF”) module provides signaling conversion (in both directions) between signaling system 7 (“SS7”) and IP networks. A policy decision function (“PDF”) module controls traffic entering the packet-switched network by allocating or denying IP bearer resources.

For a functional perspective, the carrier communication network employing IMS uses a layered architecture and includes a set of interfaces, SIP proxies and servers (such as media servers), and media gateways (for connections to non-IP networks such as the circuit-switched core or the PSTN). A feature of the layered approach is that call and session control in IMS are independent of the service layer and access network. A strength of the architecture is that it extends the IP network from user equipment through the control layers to the service or called party, while remaining independent of the type of access network. Thus, the architecture works both with legacy networks and new access networks.

While the vision of real time multimedia communications and services has been around for decades, the ability to deliver that vision has failed to materialize beyond the laboratory. IMS takes an approach that segregates the access and transport from the control and services planes in a way that will enable a whole host of applications to be delivered in a cost-effective manner. One of the keys to IMS is the use of SIP to control the carrier grade attributes of the circuit switched network, but with the lower cost and flexibility expected from the packet-switched network.

Service providers are planning to use the IMS architecture to support the convergence of mobile and fixed networks. IMS enables these service providers to offer a multitude of valuable services. These services will follow the subscriber across network boundaries creating a consistent and unique user experience. By creating a common service deployment infrastructure based on IMS, the service providers expect to reduce both initial capital investments and operational expenses by eliminating the need for separate platforms for each service offering. For a better understanding of IMS, see “The 3G IP Multimedia Subsystem (IMS): Merging the Internet and the Cellular Worlds,” 2nd Edition by Gonzalo Camarillo and Miguel-Angel Garcia-Martin, Wiley (2006), which is incorporated herein by reference.

The communication system as described herein takes an analogous general approach and applies the approach to the internal circuit-switched and packet-switched networks inside an enterprise. More specifically, a control layer is introduced in the enterprise communication network to provide real time access control for communication sessions from any access devices (e.g., communication devices) in the transport layer to any applications or services delivered in the services layer. The control layer serves as a gateway for communications to or from any application or system in the enterprise and creates a detailed audit trail as needed to support the needs of the business as they evolve.

As hereinafter described, services oriented architecture (“SOA”) is a leading approach to achieving uniform access to services in an enterprise. SOA is an approach to solving some of the issues the enterprise faces, but does not address the overall list of problems as an IMS-like control layer. The SOA is generally a software architecture-for developing services and does not create a hardware architecture to provide an auditable control structure. The addition of an extensible SIP-based control structure in cooperation with SOA based applications will enable faster development and complete control. For a better understanding of SOA, see “SOA Is Coming Fast. Are You Ready?,” an article by IBM Corporation (Dec. 30, 2004), and a publication by M. N. Huhns and M. P. Singh, entitled “Service-Oriented Computing: Key Concepts and Principles,” IEEE Internet Computing, pp. 75-81 (January 2005), which are incorporated herein by reference.

During the past few years, web services have unquestionably become an important information technology resource at many companies. Despite the wild hype that accompanied the emergence, web services have shown to be a dependable, deployable technology that brings together disparate computing silos. The ability to share data between different departments and different companies (as in business-to-business or B2B) has cemented the reputation as an effective enterprise-integration mechanism. Meanwhile, the ability to invoke services on remote systems has established the credibility for providing agility in rapidly changing environments and scalability in settings where levels of resource consumption need to be flexible. As a result, web services are good matches for initiatives such as on-demand computing.

At the simplest, web services provide the necessary underpinnings for sending data to a remote machine along with instructions on what to do with it. By this means, a dynamic computing infrastructure becomes possible and new services are added to the computing tapestry as needed by the enterprise. The standardized interfaces make web services like building blocks that can be assembled quickly into new configurations. However, to extend the benefits, an enterprise should begin moving from a hybrid model of traditional computing and web services to SOA.

In early 2004, Bob Sutor, director of websphere infrastructure software at IBM, aptly defined SOA as distributed computing with standards that tell us how to invoke different applications as services in a secure and reliable way and then how to link the different services together using choreography to create business processes. The heart of SOA is designing the architecture so that web services can, in fact, be orchestrated to produce a business service.

A typical example might look like this at a mortgage wholesaler. A mortgage application is received via a B2B web service interface. The server extracts the relevant information and invokes a web service in the accounting department to perform a credit check, which will likely involve a web service transaction between the accounting department and an external credit bureau. Once credit has been approved, application details are sent via a web service to several mortgage banks with a request to return a loan proposal. The proposals are evaluated by a rules engine and the most favorable one is chosen. The terms are sent back to the originator who initially submitted the application.

As can be seen, the various web services can be hosted anywhere inside or outside the enterprise. The nature of the actual computing (done by the credit bureau or the mortgage banks) is hidden behind the web services interface. The calling parties do not need to know how it is performed and simply need to be able to invoke the actions and supply the necessary data. Collectively, the various processes form a centrally important business process built up from web services.

The business process described above is a mature, well-orchestrated implementation of SOA. Getting to that level of maturity involves a sequence of steps that build incrementally on each other. One attractive aspect of web services and SOA is the ability to be implemented incrementally because SOA is concerned with just the interfaces to the business activities. How those activities are performed does not change, hence, previous investments in business logic are preserved or actually leveraged.

The incremental progression towards SOA often entails four stages as set forth below. The first stage is implementation of individual web services. Frequently, the starting point involves wrapping a web service interface around an existing application. Java applications and Microsoft.NET applications are particularly amenable to the wrapping because both platforms have built-in support for web services. In this regard, it should be noted that web services are an excellent mechanism for creating interfaces to applications residing on back-end servers and mainframes.

The second stage is SOA integration of web services, preferably within a single department. It is at this stage that benefits of open standards providing a common interface between applications and among systems become evident, especially because once a department moves to SOA, adding new services to the department's function becomes a simple process.

The third stage is SOA integration within the enterprise. In this stage, departments use web services to communicate between themselves and, at times, with various suppliers. The loan-broker scenario described above is representative of this stage. It now becomes clearer how SOA enables a dynamic enterprise that can reconfigure business processes quickly.

The fourth stage is on-demand computing through SOA. Business processes within the enterprise and in B2B contexts run on web services. Changing the computing infrastructure to match changes in business processes and to external events (such as glitches in the supply chain) becomes a much more straightforward operation. The information technology organization is agile and can provide not only configurability, but also scalability due to the modular design of its infrastructure.

The aforementioned stages often overlap and benefits can accrue to an organization faster than indicated in this hierarchy. There can be little doubt that web services are here to stay and SOA will be a de facto model for distributed computing. The fact that SOA facilitates on-demand computing makes it even more attractive.

In summary, the enterprise communications control layer architecture with its control and security servers provides an anchor for the enterprise user whether an employee, customer or corporate affiliate. Once the credentials of the user and the communication device are verified, the enterprise control layer sustains the access to applications irrespective of the users' access method or location including transitioning from one access method to another. By having such architecture in place, enterprises can ensure security, auditability, traceability and consistent access for the users.

As an example described with respect to FIG. 4, if a user via the communication device is gaining access from a carrier communication network, the I-CSCF module in the carrier control layer would send appropriate SIP messages to the control server in the enterprise control layer after authentication of the users' and communication devices' identity in the carriers' HSS. The enterprise security server would then authenticate the identity of the user and the communication device as being allowed to access specific applications and services based on the specific policies.

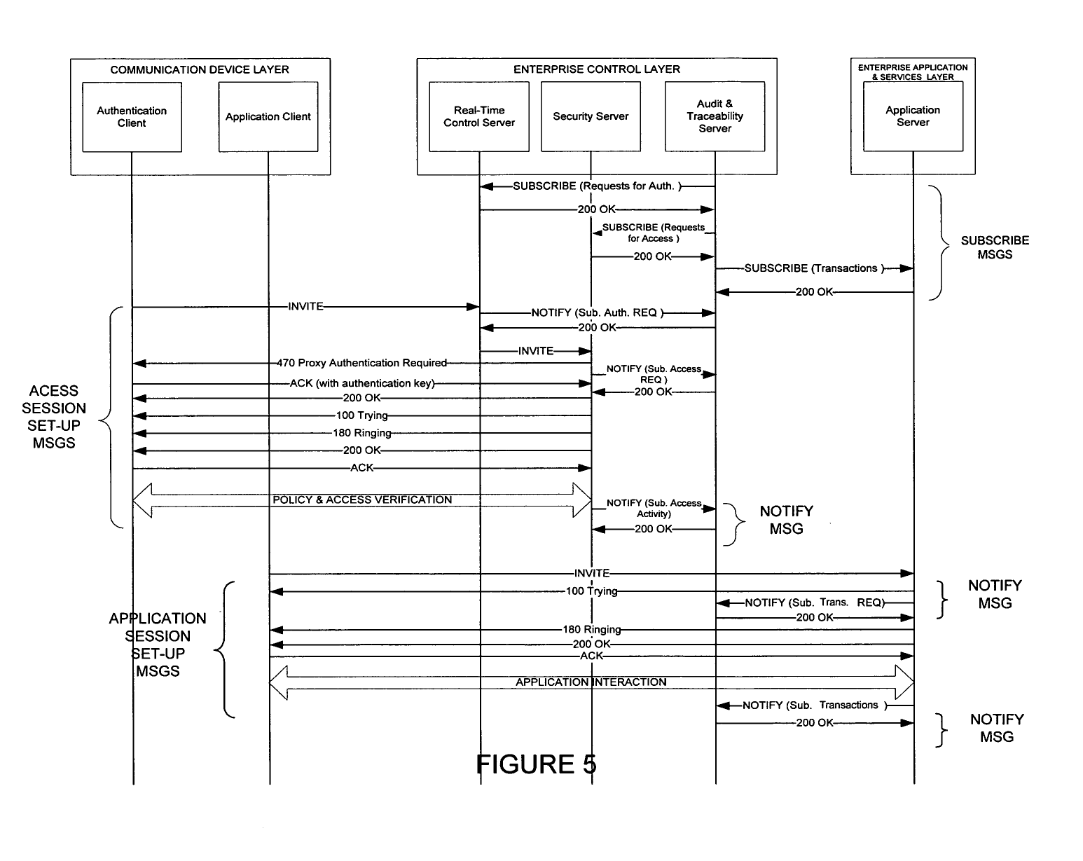

Turning now to FIG. 5, illustrated is a call flow diagram of an embodiment of a method of operating a communication system according to the principles of the present invention. In addition to other advantages, the method as described herein creates an audit trail for the communication system. An audit/traceability server has subscriber agents that register with notify agents of a control server, security server and application server to retrieve event(s) information. From the illustrated embodiment, when the user wants to access a particular enterprise application, an authentication client on a user's communication device uses SIP signaling to get clearance for the access and each interaction with the systems in the control layer is captured by the audit/traceability server as shown. After the user passes the security check, the application client, via SIP signaling, gains access to the application and the communication device can then interact with the application, with every interaction being logged and notification sent to the audit/traceability server. Since each of the notification has a time-stamp, the logs captured by the application server can be synched-up off-line for reporting purposes.

As illustrated by an initial set of messaging (designated “SUBSCRIBE MSGS”), the agent(s) on an audit/traceability control server sign-on to be notified of certain events (e.g., the subscription can be for one event or a list of events) to occur thereon. The subscribe messages may include a list of events relating to a communication device(s) and user(s) for an application or service associated with an enterprise. A notification is sent to the requesting agent (designated “NOTIFY MSGS”) after the event has occurred to record information about the event. An example of an application session being set-up between the communication device and the control layer is shown by messages designated “ACCESS SESSION SET-UP MSGS.” An authentication client on the communication client interacts with the security server via the control server to obtain access to the application server. Once access is approved by the control server in accordance with an authentication from the security server in accordance with a policy/user database, a notification is sent to the audit/traceability server to record the access transaction in accordance with a “NOTIFY MSGS.”

Once approved at the user and communication device level, the application client of the communication device interacts with the application server to set up an application session (designated “APPLICATION SESSION SET UP MSGS”). The application interaction follows the set up messages and then a notification is sent to the audit/traceability server to record the application transaction in accordance with a “NOTIFY MSGS.” The exemplary messages/signaling are in accordance with IETF standards related to SIP, which has strict directives on the composition of the header of the message. Since the messages are text-based, the body of a message is open for use by developers of solutions. The communication system of the present application provides relevant information between servers, modules and subsystems thereof in a way not contemplated by the SIP protocol.

While SIP started out as a means of initiating voice and multimedia communication sessions over the internet, it has become an umbrella protocol with new messages (methods know in the IETF-SIP parlance) being added as and when the SIP community agrees on adding the messages to satisfy a feature. For instance, SIP: INFO is an extension that adds an “INFO” method to the SIP protocol. The intent of the INFO method is to allow for the carrying of session related control information that is generated during a session. One example of such session control information is ISUP and integrated services digital network (“ISDN”) signaling messages used to control telephony call services. A system can use this message/method to exchange information between two agents that have a SIP session established. The information may not even be telephony related as long as the two agents know what is coming and how to respond. It should be noted that the aforementioned messages exchange event information that is not typically related to telephony, but to access, authentication and notification. This is like TCP/IP that was originally used for data communications, but was applied to voice once the voice information was digitized and packetized (e.g., VOIP).

Exemplary embodiments of the present invention have been illustrated with reference to specific electronic components. Those skilled in the art are aware, however, that components may be substituted (not necessarily with components of the same type) to create desired conditions or accomplish desired results. For instance, multiple components may be substituted for a single component and vice-versa. The principles of the present invention may be applied to a wide variety of network topologies.

For examples of other communications systems, see U.S. Patent Application Publication No. 2003/0018540 entitled “System and Method for providing Requested Information to Thin Clients,” to Volpi, et al., published Jan. 23, 2003, U.S. Patent Application Publication No. 2004/0174900 entitled “Method and System for Providing Broadband Multimedia Services,” to Volpi, et al., published Sep. 9, 2004, and U.S. Patent Application Publication No. 2006/0171402 entitled “Method and System for Providing Broadband Multimedia Services,” to Moore, et al., published Aug. 3, 2006, which applications are hereby incorporated herein by reference.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A communication system employable with an enterprise that provides applications for a user through a communication device, comprising:
a policy/user database configured to store policies across an enterprise related to said user and said communication device for access to said applications within said enterprise;
a security server configured to authenticate access of said communication device to said applications based on said policies;
a control server configured to approve and control access of said communication device to said applications based on authentication from said security server; and
an audit/traceability server configured to provide a record of transactions for said access by said communication device to said applications and provide an alert in real time when approval is denied.

2. The communication system as recited in claim 1 wherein said security server is configured to authenticate access of said user of said communication device to said applications based on said policies and said control server is configured to approve and control access of said user of said communication device to said applications based on authentication from said security server.

3. The communication system as recited in claim 1 wherein said enterprise provides services to said user of said communication device, said policy/user database being configured to store policies across an enterprise related to said user and said communication device for access to said services within said enterprise, said security server being configured to authenticate access of said communication device to said services based on said policies, said control server being configured to approve and control access of said communication device to said services based on authentication from said security server, and said an audit/traceability server being configured to provide a record of transactions for said access by said communication device to said services and provide an alert in real time when approval is denied.

4. The communication system as recited in claim 1 wherein said control server is configured to disable said communication device when approval is denied.

5. The communication system as recited in claim 1 policy/user database is configured to store biometric information about said user and said security server is configured to authenticate access of said user to said applications based on said biometric information.

6. The communication system as recited in claim 1 wherein said applications are selected from the group consisting of:
enterprise resource planning applications,
customer relations management applications, and
supply chain management applications.

7. The communication system as recited in claim 1 wherein said communication device is selected from the group consisting of:
a voice over internet protocol phone,
a laptop personal computer,
a desktop personal computer,
a personal digital assistant,
a cell phone, and
an instant messaging client residing on a communication device.

8. The communication system as recited in claim 1 wherein said control server is configured to employ a session initiation protocol to facilitate a communication session for said communication device in accordance with said applications.

9. The communication system as recited in claim 1 wherein said control server is configured to facilitate a multimedia communication session for said communication device in accordance with said applications.

10. The communication system as recited in claim 1 wherein said control server is coupled to applications servers associated with said enterprise.

11. A method of operating a communication system employable with an enterprise that provides applications for a user through a communication device, comprising:
storing policies across an enterprise related to said user and said communication device for access to said applications within said enterprise;
authenticating access of said communication device to said applications based on said policies;
approving access of said communication device to said applications based on authenticating access of said communication device to said applications;
controlling said access of said communication device to said applications based on approving access of said communication device to said applications;
providing a record of transactions for said access by said communication device to said applications; and
providing an alert in real time when approval is denied.

12. The method as recited in claim 11, further comprising:
authenticating access of said user of said communication device to said applications based on said policies;
approving access of said user of said communication device to said applications based on authenticating access of said user of said communication device to said applications; and
controlling said access of said user of said communication device to said applications based on approving access of said user of said communication device to said applications.

13. The method as recited in claim 11 wherein said enterprise provides services to said user of said communication device, said method, further comprising:
storing policies across an enterprise related to said user and said communication device for access to said services within said enterprise;
authenticating access of said communication device to said services based on said policies;
approving access of said communication device to said services based on authenticating access of said communication device to said services;
controlling said access of said communication device to said services based on approving access of said communication device to said services;
providing a record of transactions for said access by said communication device to said services; and
providing an alert in real time when approval is denied.

14. The method as recited in claim 11 further comprising disabling said communication device when approval is denied.

15. The method as recited in claim 11 further comprising storing biometric information about said user and authenticating access of said user to said applications based on said biometric information.

16. The method as recited in claim 11 wherein said applications are selected from the group consisting of:
enterprise resource planning applications,
customer relations management applications, and
supply chain management applications.

17. The method as recited in claim 11 wherein said communication device is selected from the group consisting of:
a voice over internet protocol phone,
a laptop personal computer,
a desktop personal computer,
a personal digital assistant,
a cell phone, and
an instant messaging client residing on a communication device.

18. The method as recited in claim 11 further comprising employing a session initiation protocol to facilitate a communication session for said communication device in accordance with said applications.

19. The method as recited in claim 11 further comprising facilitating a multimedia communication session for said communication device in accordance with said applications.

20. The method as recited in claim 11 wherein said applications reside on applications servers associated with said enterprise.
